(19) United States
(12) Patent Application Publication
(10) Pub. No.: US 2007/0067217 A1
(43) Pub. Date: Mar. 22, 2007

(54) System and method for selecting advertising

(76) Inventors: Joshua Schachter, New York, NY (US); Albert Wenger, Scarsdale, NY (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/231,337

(22) Filed: Sep. 20, 2005

(51) Int. Cl. G06Q 30/00

(52) U.S. Cl. 705/14

(57) ABSTRACT

One aspect relates to a system for collecting user classifications of content and using such classifications to match ads to appropriate content. In such a manner, more appropriate associations between ads and content may be made. Such classifications may be collected, for example, using a social bookmarking system.

### BACKGROUND OF THE INVENTION

1. Field of the Invention

The field of the invention relates generally to Internet technologies, and more specifically, to web-based advertising.

2. Discussion of Related Art

A basic problem for publishers of content on the Internet is how to match available advertising, whether in the form of banners, text, or rich media, with content. Current approaches to this problem include Google's AdSense program. The AdSense program allows a website publisher to dynamically serve relevant advertisements on web pages by analyzing text on a web page and automatically selecting ads based on the page content. The AdSense program also allows for the website publisher to provide explicit “hints” in the form of keywords to suggest associations of content. In any case, if a visitor selects (e.g., clicks on) one of the AdSense ads served to the website, the website publisher is credited for the referral and is provided a fee. Google's AdSense program essentially allows approved websites to dynamically serve Google's advertisements paid for by advertisers.

Website maintenance related to the AdSense program requires very little effort. Webmasters need only to insert a Google-generated java script program into the web page or website template. A well-known spider program parses the website upon which the AdSense program is associated and serves ads that relate to the website's content. The AdSense program uses a combination of keyword matching and context analysis to determine what ads should be served. The java script program calls the ad from a Google website and ensures that ads are served each time a visitor loads a web page. AdSense also implements a filtering system that allows webmasters to prevent a specific domain's ads from being served on any websites in their account. By performing ad blocking, webmasters could prevent their competitor's ads from being dynamically served on their websites.

### SUMMARY OF THE INVENTION

Conventional ad matching programs such as the AdSense program do not, in all cases, optimally match ads to content. According to one aspect of the present invention, it is appreciated that automatic methods of analyzing content based on contextual and keyword analysis do not always optimally match ads to corresponding web pages. A result of this suboptimal matching is that ads placed on these web pages generate less results (e.g., responses to ads that result in actions, “click-through” traffic, purchases, etc.) than ads that are correctly matched. Thus, an alternative method for matching ad content to website content is needed.

According to one aspect of the present invention, a method is provided for developing user-based classifications and using the resulting user classifications to determine advertising associations. According to one specific aspect of the present invention, it is appreciated that users viewing website content are more capable of determining classification than automated programs. However, one drawback to manual classification is that the volume of available information on the Internet to be classified is too great for one entity to classify. Therefore, according to one embodiment of the present invention, a distributed system for collecting content classifications is provided. Such user classifications may be used alone or with conventional contextual classification mechanisms to determine matches between ads and website content.

According to one aspect of the present invention, Internet users bookmark Internet content, creating user classification data of that content. Such classification data may, for example, be in the form of one or more “tags” which, in one specific example, are keywords that the user associates with an Internet page. Although tag data may be used, it should be appreciated that other types of classification data can be used to classify data.

For instance, classification data may be in the form of a folder-based or other type of hierarchical structure used to organize information. Such a structure may be, for instance, a predetermined hierarchical structure in which users “place” content or references to content. In particular, the predetermined hierarchical structure may be predetermined by the user. In another example, the predetermined hierarchical structure is determined by some person or entity other than the user, and the user only places the content or references to content. In another example, users are capable of determining or suggesting one or more aspects of the classification structure. Traditionally, website developers could, in particular systems, subscribe their websites to a classification system (e.g., Yahoo) in which the website developers suggest particular tags or other classification data. However, according to one embodiment, the user is capable of determining how and what classifications are ascribed to content rather than the originators themselves.

According to one aspect of the present invention using tags, it is appreciated that these tags often provide very valuable clues as to what advertising should be displayed with a particular page, as the tags provide a subjective view as to what classification the user associates with that content, regardless of the actual content (e.g., keyword) that appear with the content. For instance, an article describing a restaurant in Miami might be tagged by many users as “vacation” or “travel”. However, such as article may not include keywords that contain the terms “vacation” or “travel” or otherwise be contextually associated with these classifications. Thus, a user-defined classification may provide a more useful classification than an automatically-generated one based on content.

The tags and their associated page references may be provided (e.g., sold) to a website publisher for determining ad placement. In particular, the publisher could then use the provided tag information to select the appropriate ads for each page. These “tags” might also be used as keywords to be input into a system such as the AdSense program to associate ads with content. In the specific example of the AdSense program, the user classifications may be provided as hint data to the AdSense program. Thus, a more accurate way may be provided to associate ads to content, and to provide increased “click-through” traffic to those ads as a result.

According to one aspect of the present invention, a method for selecting advertising is provided. The method comprising acts of collecting classification data from a plurality of users, wherein at least one portion of the classification data indicates a classification of content, determining, based on the at least one portion of the classification data, an advertisement; and

associating the advertisement with the content. According to one embodiment of the invention, the act of collecting classification data further comprises an act of collecting one or more tags. According to another embodiment of the present invention, the act of collecting the classification data further comprises an act of determining a classification performed through a user action. According to another embodiment, the act of determining includes determining whether the user associated the content with a particular classification.

According to another embodiment of the invention, one or more tags include one or more keywords that describe the content. According to another embodiment of the invention, the act of collecting the one ore more tags further comprises an act of collecting the one or more tags by a collaborative computer system operated by the plurality of users. According to another embodiment of the invention, the content includes a website page and wherein the act of associating includes an act of associating the advertisement with the website page. According to another embodiment of the invention, the advertisement includes data, and the act of associating further comprises an act of associating the data with the content.

According to one embodiment of the invention, one or more keywords are derived from at least one of the plurality of users. According to another embodiment of the invention, the method further comprises an act of inputting the one or more keywords into an ad-matching program. According to another embodiment of the invention, the method further comprises an act of providing the classification data to an entity to be used to determine the association of the advertisement with the content. According to another embodiment of the invention, the act of collecting classification data is performed by a plurality of computer systems. According to another embodiment of the invention, the classification data is shared among a plurality of computer systems. According to another embodiment of the invention, the content is referenced by reference data, and wherein the act of associating includes an act of associating the advertisement with the reference data. According to another embodiment of the invention, the reference data includes a Uniform Resource Locator (URL). According to another embodiment of the invention, the classification data is shared among a plurality of application programs. According to another embodiment of the invention, the classification data is shared among the plurality of users.

According to one aspect of the present invention, a system for selecting advertising is provided. The system comprises an ad-matching component adapted to match an advertisement with content, a classification system adapted to provide classification data collected from a plurality of users, wherein the classification data includes a portion that classifies the content and wherein the ad-matching component is adapted to use the portion to determine the association of the advertisement with the content. According to one embodiment, the classification system is adapted to collect one or more tags. According to another embodiment of the invention, one or more tags include one or more keywords that describe the content.

According to another embodiment of the invention, the classification system further comprises a collaborative computer system operated by the plurality of users. According to another embodiment of the invention, the ad-matching component further comprises means for associating the advertisement with the content. According to another embodiment of the invention, the one or more keywords are derived from at least one of the plurality of users. According to another embodiment of the invention, the plurality of users collectively provide the classification data. According to another embodiment of the invention, the content is referenced by reference data, and wherein the ad-matching component is adapted to associate the advertisement with the reference data. According to another embodiment of the invention, the reference data includes a Uniform Resource Locator (URL). According to another embodiment of the invention, the system further comprises a plurality of application components that share the classification data. According to another embodiment of the invention, the classification system is adapted to share the classification data among the plurality of users. According to another embodiment, the classification system is adapted to determine a classification performed through a user action. According to another embodiment, the classification system is adapted to determine whether the user associated the content with a particular classification.

According to another aspect of the present invention, a computer-readable medium is provided having computer program code stored thereon, when executed by one or more computer systems, causes the computer system(s) to perform acts of collecting classification data from a plurality of users, wherein at least one portion of the classification data indicates a classification of content, determining, based on the at least one portion of the classification data, an advertisement, and associating the advertisement with the content. According to one embodiment, the act of collecting classification data further comprises an act of collecting one or more tags. According to another embodiment, the act of collecting the classification data further comprises an act of determining a classification performed through a user action. According to another embodiment, the act of determining includes determining whether the user associated the content with a particular classification. According to another embodiment of the invention, one or more tags include one or more keywords that describe the content.

According to another embodiment of the invention, the act of collecting the one ore more tags further comprises an act of collecting the one or more tags by a collaborative computer system operated by the plurality of users. According to another embodiment of the invention, the content includes a website page and wherein the act of associating includes an act of associating the advertisement with the website page. According to another embodiment of the invention, the advertisement includes data, and the act of associating further comprises an act of associating the data with the content. According to another embodiment of the invention, one or more keywords are derived from at least one of the plurality of users. According to another embodiment of the invention, the computer-readable medium comprises an act of inputting the one or more keywords into an ad-matching program.

According to one embodiment of the invention, the computer-readable medium comprises an act of providing the classification data to an entity to be used to determine the association of the advertisement with the content. According to another embodiment of the invention, the act of collecting classification data is performed by a plurality of computer systems. According to another embodiment of the invention, the classification data is shared among a plurality of computer systems. According to another embodiment of the invention, the content is referenced by reference data, and wherein the act of associating includes an act of associating the advertisement with the reference data. According to another embodiment of the invention, the reference data includes a Uniform Resource Locator (URL). According to another embodiment of the invention, the classification data is shared among a plurality of application programs. According to another embodiment of the invention, the classification data is shared among the plurality of users.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows an example computer system upon which various aspects of the present invention may be implemented;

FIG. 2 shows an example system architecture according to one embodiment of the present invention;

FIG. 3 shows an example process for creating classification data according to one embodiment of the present invention;

FIGS. 4A-4B show an example process for creating classification data according to one embodiment of the present invention;

FIG. 5 shows an example interface through which a user may enter classification information according to one embodiment of the present invention;

FIG. 6 shows an example interface of a social bookmarking system that may be used to produce classification data according to one embodiment of the present invention; and

FIG. 7 shows an example interface showing a personal page that may be used to classify data according to one embodiment of the present invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

As discussed above, one aspect of the present invention relates to system for collecting user classifications of content and using such classifications to match appropriate ads to corresponding content. In such a manner, more appropriate associations between ads and content may be made.

Another aspect of the invention relates to a process for creating user classifications. More specifically, a distributed process for creating a classification data is provided that allows a user to create classifications of content that may be shared among systems, applications and users. Generally, there are many ways that users can classify data. However, classifications of data are generally limited to a specific user, applications and/or systems. For instance, e-mail items in the well-known Microsoft Outlook application program are restricted to the folders created within the application. Thus, a user could not use the same folder to organize items other than those types available within the Outlook application program.

According to one aspect of the present invention, it is realized that there are restrictions to using classification structures across domains, such as users, systems, and applications. According to one specific aspect of the present invention, a system is provided wherein classification structures can be shared among data objects (e.g., those that contain content) in an open manner. To this end, a distributed system is provided for sharing classifications and references to content.

The system may be adapted to display, for example, reference information such as Uniform Resource Locator (URL) information. Such reference information may refer, for example, to a website page referenced by a URL address. In one embodiment, the system is capable of storing one or more user classifications associated with content referenced by the URL. The classification information may be, according to one embodiment of the present invention, tag information including one or more keywords that describe the referenced content.

A tag may itself have more than one keyword associated with it (e.g., a multiple word tag). Such tags using multiple elements may include, for example, one or more keywords presented in a particular format. In one example using a multiple word tag, keywords may be separated by one or more spaces (e.g., “household pet”), other types of characters (e.g., “books:fiction”), or no character (e.g., “newyorkyankees”). It should be appreciated that tags may have any type of formatting, and the invention is not limited to single-word tags.

Such tag information may be collected in a distributed manner from multiple users. Users may also be permitted to view tags used by other users to classify a particular page, and to use other's classifications for classifying content. To this end, the system may present to a user a listing of classifications used by other users to classify currently-viewed content.

The system may include, in one specific example, a system for managing bookmarks in a browser program executing on a local computer system. Such bookmark manager programs are well-known, and are used to organize URL information. Examples include the del.icio.us bookmarking system and Internet service, available at http://del.icio.us, the Spurl.net bookmarking system and service available at http://www.spurl.net, among others. According to one aspect of the present invention, a distributed bookmark manager that collects tag information from multiple users is used to determine classification information that determines ad placement for content (e.g., as referenced by URL data).

In one such bookmark management system, a bookmark management program is executed by a user's browser program. The bookmark management program performs functions relating to storing and classifying URL information based on input from the user. For example, the bookmark management program permits the user to associate a currently-viewed URL with one or more keywords or “tags.”

In one such bookmark manager program, URLs classified by the user are stored in a database located on a network (e.g., stored centrally on a network server or distributed among a number of systems in a distributed database). In this way, the user may access his/her bookmarks from one or more systems or locations. Further, because bookmark information is located on a server, such information may be shared with other systems and/or users. For example, bookmark information may be shared among a plurality of users, the users operating a client system. The users may, for example, use a browser program (e.g., the Microsoft Internet Explorer browser program or other type of browser program) to access a bookmark service to classify information. Users may, alternatively or in addition to accessing bookmark information through a browser program, access bookmark information through one or more application programs and/or operating systems.

According to various aspects of the present invention, a server-based system may collect classification from one or more client types. In one example, the client system may be a browser-based system that permits the user to classify content and provide classification data to the server-based system in real time. However, the server-based system may collect classification information from other types of clients (e.g., thick or thin clients, different types of client systems (cell phones, PDAs, web servers, etc.), different types of programs (OSs, programs, etc.). These other types of clients may provide such classification in real time, may provide information periodically, or may provide information at defined times (e.g., when a specific action is taken on the client). In this way, the server system is capable of collecting and distributing classification information to a variety of client and system types.

According to one embodiment of the present invention, such tag information is collected by a collaborative system that collects tag information from multiple users. The system may include a number of features to facilitate user's classifications, such as, for example, displaying classifications from other users for the same content. This feature may permit, for example, the user to refine their own use of tags, or use additional tags for classifying a particular content reference (e.g., URL). Further, the system may show, to the user, URLs associated with the same or related tag information. This feature may allow the user to locate related content previously located and classified by other users. Other features may include a listing of most recently bookmarked URLs, most frequently bookmarked URLs, and a subscription feature that allows a user to subscribe to other's bookmarks having similar interests.

The system may also be capable of providing any or all of the bookmark information to other programs via, for example, an RSS feed, API, or other programming mechanism. The interface to the system may permit, for example, the user and/or applications to store, edit, categorize, and retrieve bookmark information. Thus, application developers may extend the functions of applications including, but not limited to, browsers, desktop client programs, and API bindings for various programming languages. The system may store the information in one or more databases (e.g., object, relational, or other database type). Alternatively or in addition to traditional databases, information may be stored in any other database format such as flat-file or other data structure file format (e.g., XML).

In this way, user classifications may be collected and provided to website owners or other entities for determining ad placement. Such classification information may be sold to entities that provide Internet services, such as, for example ad services and/or Internet search services. Further, such classification information may be used to locate Internet resources in place of or along with conventional Internet search utilities.

General Purpose Computer System

Various embodiments according to the present invention may be implemented on one or more computer systems. These computer systems may be, for example, general-purpose computers such as those based on Intel PENTIUM-type processor, Motorola PowerPC, AMD Athlon or Turion, Sun UltraSPARC, Hewlett-Packard PA-RISC processors, or any other type of processor. It should be appreciated that one or more of any type computer system may be used to determine ad placement according to various embodiments of the invention. Further, the system may be located on a single computer or may be distributed among a plurality of computers attached by a communications network.

A general-purpose computer system according to one embodiment of the invention is configured to perform any of the described functions, including but not limited to, storing, editing, categorizing, and retrieving bookmark information. It should be appreciated that the system may perform other functions, including storing and/or managing bookmark information, sharing bookmark information, etc., and the invention is not limited to having any particular function or set of functions.

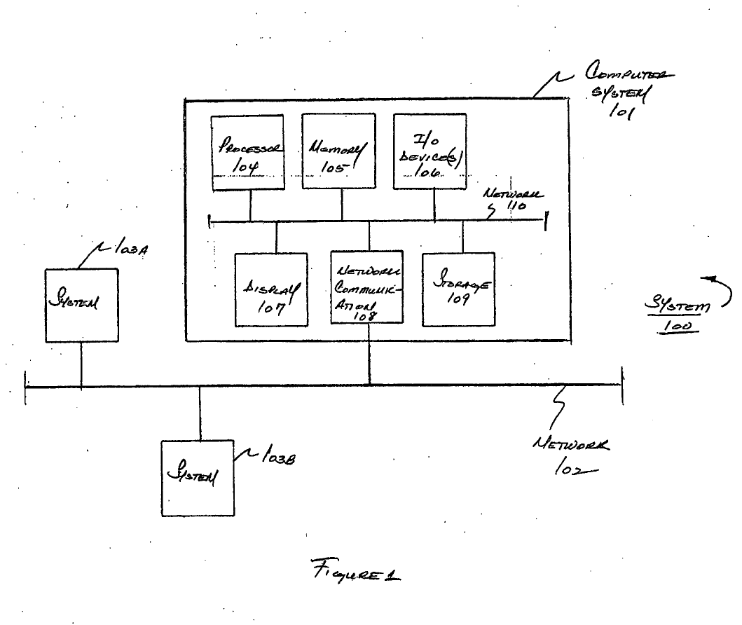

FIG. 1 shows a block diagram of a general purpose computer and network system in which various aspects of the present invention may be practiced. For example, various aspects of the invention may be implemented as specialized software executing in one or more computer systems including general-purpose computer system 101 shown in FIG. 1. Computer system 101 may include a processor 104 connected to one or more memory devices 105, such as a disk drive, memory, or other device for storing data. Memory 105 is typically used for storing programs and data during operation of the computer system 101. Components of computer system 101 may be coupled by an interconnection mechanism such as network 110, which may include one or more busses (e.g., between components that are integrated within a same machine) and/or a network (e.g., between components that reside on separate discrete machines). The interconnection mechanism enables communications (e.g., data, instructions) to be exchanged between system components of system 101.

Computer system 101 also includes one or more input/output (I/O) devices 106, for example, a keyboard, mouse, trackball, microphone, touch screen, a printing device, display screen, speaker, etc. In addition, computer system 101 may contain one or more interfaces (e.g., network communication device 108) that connect computer system 101 to a communication network (in addition or as an alternative to the network 110.

The storage system 109, typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). The memory may be located in storage system 109, as shown, or in memory system 105. The processor 104 generally manipulates the data within the integrated circuit memory 104, and then copies the data to the medium associated with storage 109 after processing is completed. A variety of mechanisms are known for managing data movement between the medium and integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 101 is shown by way of example as one type of computer system upon which various aspects of the invention may be practiced, it should be appreciated that aspects of the invention are not limited to being implemented on the computer system as shown in FIG. 1. Various aspects of the invention may be practiced on one or more computers having a different architectures or components that that shown in FIG. 1.

Computer system 101 may be a general-purpose computer system that is programmable using a high-level computer programming language. Computer system 101 may be also implemented using specially programmed, special purpose hardware. In computer system 101, processor 104 is typically a commercially available processor such as the well-known Pentium class processor available from the Intel Corporation. Many other processors are available. Such a processor usually executes an operating system which may be, for example, the Windows-based operating systems (e.g., Windows NT, Windows 2000 (Windows ME), Windows XP operating systems) available from the Microsoft Corporation, MAC OS System X operating system available from Apple Computer, one or more of the Linux-based operating system distributions (e.g., the Enterprise Linux operating system available from Red Hat Inc.), the Solaris operating system available from Sun Microsystems, or UNIX operating systems available from various sources. Many other operating systems may be used, and the invention is not limited to any particular operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to a communications network. These computer systems also may be general-purpose computer systems. For example, various aspects of the invention may be distributed among one or more computer systems (e.g., servers) configured to provide a service to one or more client computers, or to perform an overall task as part of a distributed system. For example, various aspects of the invention may be performed on a client-server or multi-tier system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Various aspects of this system can be implemented by one or more systems within system 100. For instance, the system may be a distributed system (e.g., client server, multi-tier system). In one example, the system includes software processes executing on a system associated with a user (e.g., a client system). These systems may permit the user to associate classification information with one or more references to content (e.g., a URL).

Example System Architecture

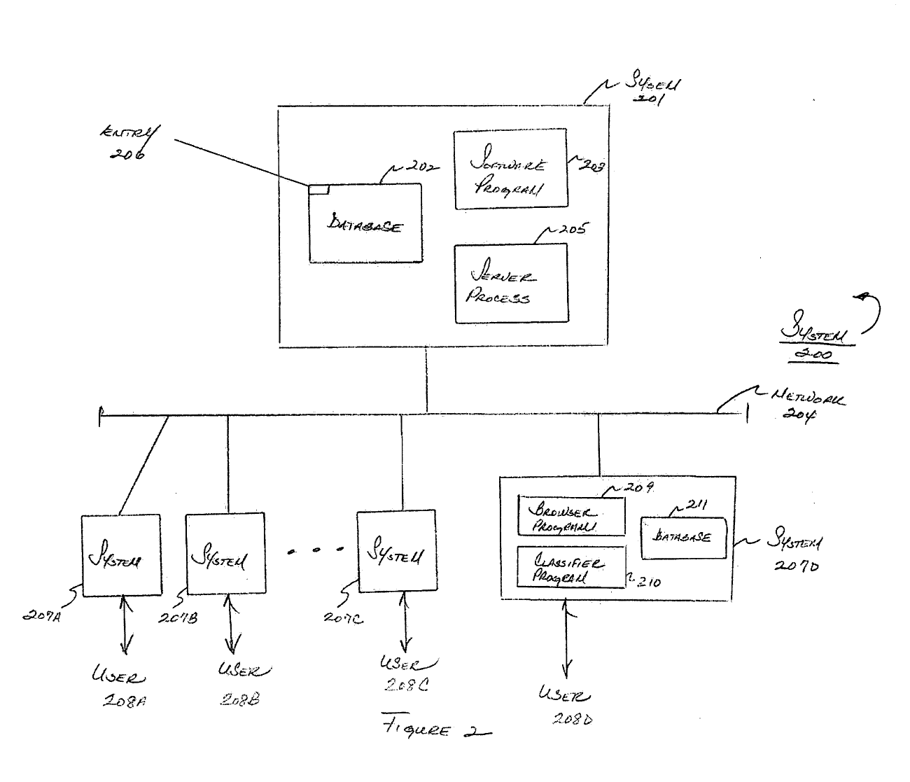

FIG. 2 shows an architecture diagram of an example system according to one embodiment of the invention. It should be appreciated that FIG. 2 is used for illustration purposes only, and that other architectures may be used to facilitate one or more aspects of the present invention.

As shown in FIG. 2, a distributed system 200 may be used to create and store user classification information. System 200 may include one or more computer systems (e.g., systems 201, 208A-D) coupled by a communication network 204. Such computer systems may be, for example, general-purpose computer systems as discussed above with reference to FIG. 1.

In one embodiment of the present invention, system 201 stores classification information in the form of tag information in one or more databases (e.g., database 202). Further, system 201 performs associated functions with the tag information.

System 201 may include a server process (e.g., process 205) that responds to requests from one or more client programs. Process 205 may include, for example, an HTTP server or other server-based process (e.g., a database server process, XML server, peer-to-peer process) that interfaces to one or more client programs distributed among one or more client systems (e.g., systems 207A-207D).

According to one embodiment, client programs may be capable of permitting a user to classify content. Such programs may include, for example, any type of operating system and/or application program capable of communicating with system 201 through network 204. In one particular instance, a client may include a browser program (e.g., browser program 209) that communicates with server process 205 using one or more communication protocols (e.g., HTTP over a TCP/IP-based network, XML requests using HTTP through an Ajax client process, distributed objects, etc.).

Although it is shown by way of example that a browser program may be used to classify data, it should be appreciated that other program may be used to interface a user to server process 205. For instance, an application program that is specially-developed to manage classification data may be provided to permit a user to perform classifications according to one embodiment of the present invention. The client program may be, for example, a thin client including an interface for managing classification data, although such classification data may or may not be stored on the client. Alternatively, the client may be a scripted program, or any other type of program having the capability of transferring classification data. According to one embodiment, such client programs may, for example, be downloaded and installed over the network. Further, these client programs may be stored and distributed by system 201 in the form of one or more software programs 203.

In one specific example, the client program may include a classifier program 210 that permits the user to associate classification data with one or more references to content (e.g., URLs). This classifier program 210, in one embodiment, may be integrated with browser program 209 executing on system 207D. For instance, the classifier program 210 may include one or more controls that, when selected by the user, perform storing, editing, and other functions of tag information. These controls may be written in a variety of programming languages, and the invention is not limited to any particular language. In one specific example, the control may be a bookmark that, when accessed, performs one or more programmed functions.

In one embodiment, the controls may be displayed as selections in the user's bookmark list. When selected, one type of control may permit the user to associate tag information with the currently-viewed URL. In another type of control, the user may be permitted to view a list of tags previously associated with the user. To this end, the user may be presented a web page that includes defined tags and their associated URL data. Yet another type of control may permit the user to see tags defined by others. In particular, the system may permit a user to see what other users have bookmarked a specific URL. Further, the capability may be provided for a user to view URLs collected by others, and subscribe to the links of users whose lists of URLs are interesting to the user. Additional capabilities may be provided to permit the user to organize Internet information and to benefit by other's previous organization of content.

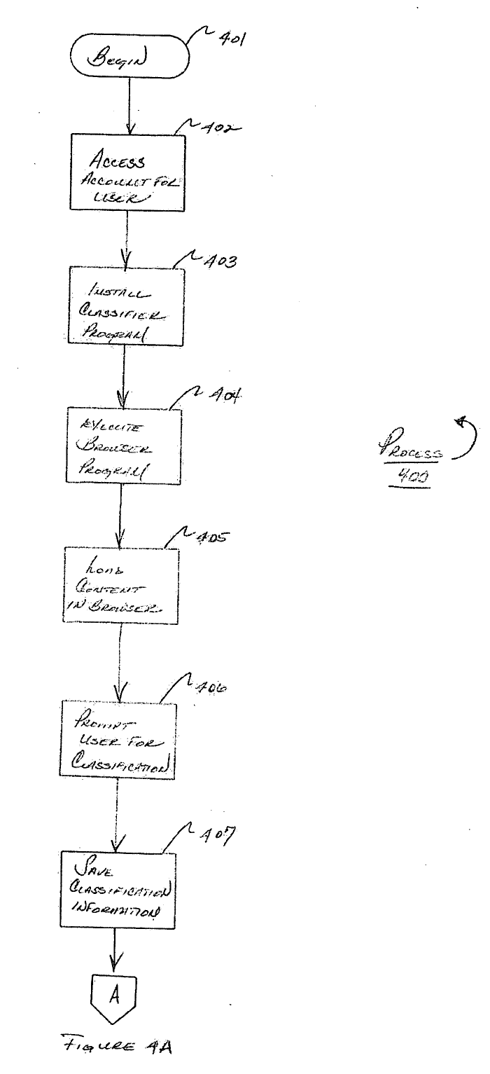

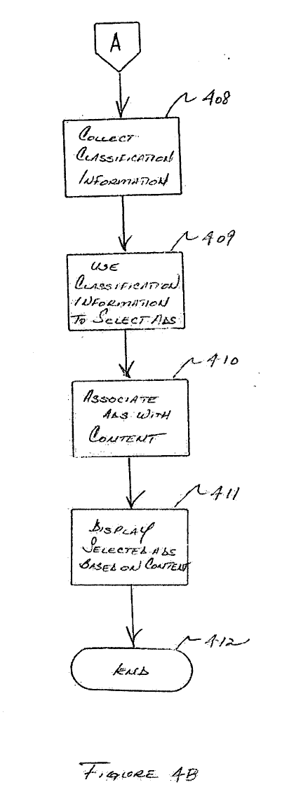

Information stored in the database 202 may include, for example, a URL address, one or more keywords associated with the URL address, a description of the URL, among other information that may be used to describe and classify content. This information may be collected from the user in an interface (e.g., as described below with reference to FIG. 4) and stored in the database (e.g., database 202). Additionally, client systems may store a local copy of a user's tag information with a local database associated with the client system (e.g., database 211 located on client system 207D). However, it should be appreciated that the invention is not limited to storing classification information in any particular location.

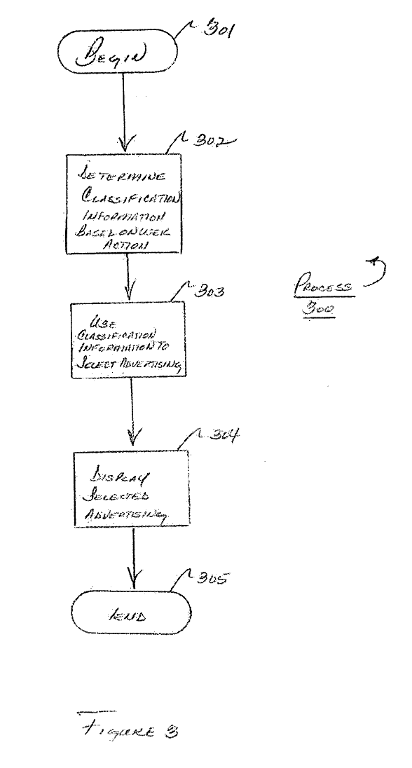

FIG. 3 shows a general process 300 for creating classification data according to one embodiment of the present invention. At block 301, process 300 begins. In one example system, a user may be capable of providing classification data that classifies one or more portions of content. At block 302, a computer system (e.g., a client computer, server computer or other computer or process) determines classification data based on a user action. For instance, the user may associate one or more tags with content, place a portion of content in a particular folder, or any other user action that may be used to create a classification.

Further, a computer system may store the classification. The classification data may be stored locally at a computer system operated by the user, and/or may be stored centrally at a server. In one embodiment, classification data may be stored for each user over time. Such advertising may be ads that are available to be displayed to a particular user, and selected for individual users based on the stored classifications.

At block 303, the classification data is used select advertising to be displayed to a user. For instance, the advertising may be displayed to the user in a current computer session based on the classification provided. Further, advertising may be selected based on stored classification information for the user. For instance, for a particular portion of content (e.g., one referenced by a URL), one or more of the most frequently-occurring keywords associated with a particular URL may be used as classification information to determine selected advertising. In one specific example, such keywords may be used as inputs to an ad-matching program such as AdSense to determine advertising selected for display to the user.

At block 304, the selected ads may displayed to the user. Such display may occur, for example, on a display associated with the same or a different computer system. Further, the selected ads may be displayed in a presently-occurring or future computer session. At block 305, process 300 ends.

FIGS. 4A-4B show an example process 400 for creating classification (e.g., tag) data according to one embodiment of the present invention. At block 401, process 400 begins. In one example system (e.g., system 200 discussed above with reference to FIG. 2), a user may have an associated user account with which tag information is associated. This account may permit, for example, the user to access tag information from multiple systems, to share tag information with other users, and other functions.

At block 402, the user accesses his/her account. Access may be performed, for example, by the user entering a login identifier (e.g., a user name) and password. Optionally, it is determined whether the user has an associated account, and if not, the user may be permitted to create an account to manage his/her tag information. If, for example, the system on which the user is operating does not have an associated client program installed, the system may install any necessary software (e.g., classifier program 210) at block 403. The software may be programmed in any language or combination of languages, and the invention is not limited to any particular language or set of languages.

As discussed above, the client program may be integrated with a browser program (e.g., browser program 209) installed on the client system (e.g., system 207D). At block 405, the user loads content into a browser program interface by, for example, entering a specific URL in an address line of the browser interface, or by selecting a link to the URL from another URL reference (e.g., a search function).

The user may select to classify the currently-viewed URL by, for example, selecting a control within an interface of the browser. In response to selecting the control, the program may prompt the user at block 406 to classify the content. The prompting may be displayed, for example, in a same of different window of the browser interface that displays the selected content. Specifically, the interface may prompt the user to enter one or more tags associated with the URL. These tags may be, according to one embodiment, keywords that describe the content referenced by the URL.

At block 407, the system saves the collected classification information. As discussed, the information may be stored in a database of a server coupled to the client over a communication network. Classification information may also be stored local to the client (or in any other location) so that the information may be accessed by the client when not connected to the network, or when the information is accessed by other applications when not connected to the network.

At block 408, the classification information may be collected and maintained by the system over time. For instance, the system may maintain classification information received from individual users over time. This information may be consolidated and used as classification information to select advertising at block 409. For instance, for a particular URL, one or more of the most frequently-occurring keywords associated with a particular URL may be used as classification information to determine selected advertising. In one specific example, such keywords may be used as inputs to an ad-matching program such as AdSense.

Once selected, the ads may be associated with the URL described by the classification information (e.g., at block 410). The ads themselves may include data and/or programs that present advertisements to users. The ad content may be linked with, embedded in, or otherwise associated with the web page referenced by the URL. The ads may be displayed when the URL is subsequently loaded in a browser program (e.g., block 411). The URL may be subsequently loaded by the same or a different browser program instance (e.g., a browser program instance existing on another client system). In this manner, user-selected classifications of the content may be used to associate ads with the referenced content. At block 412, process 400 ends.

Although FIGS. 4A-4B discussed above show a process that involves the creation of classifications using a browser program, it should be appreciated that classifications may be performed using any type of computer system and/or application, and the invention is not limited to any particular implementation. For example, the classification system may be implemented in an operating system and/or application, permitting users and/or programs to classify information, and any resulting classification information can be used to associate ads with content.

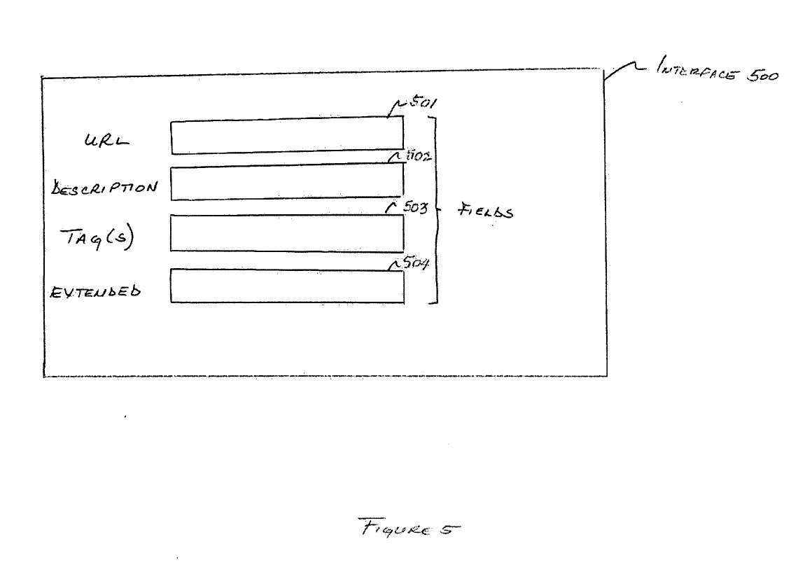

FIG. 5 shows an example interface in which classification information may be entered by a user into the system (e.g., system 200). Interface 500 may be presented to the user in a display of a computer system (e.g., a client system). Interface 500 may include, for example, an entry window having one or more fields (e.g., fields 501-504) in which data may be entered. The entry window may be the same or a different window used to display the content to be classified. In one specific example, the entry window may be shown in a browser interface or portion thereof. For instance, the entry window may be displayed in a frame of the browser interface.

As discussed above, the entry window may include one or more data entry fields in which classification information may be entered. In particular, the entry window may include a URL field 501 in which a URL address or other reference information may be entered. Interface 500 may also include a description field 502 that includes, for example, a text-based description of the URL content. By default, description 502 may include a stored title or filename of the content. Interface 500 may also include a tag field 503 in which classification information may be entered. In one example, the classification information may be in the form of one or more keywords associated with the content reference. Interface 500 may include other information, stored in the above or additional fields. For instance, an extended field 504 may be used to store an extended description of the content entered by the user. This extended field 504 may also include one or more tags or other classifying information that may be used to describe content.

According to one specific embodiment of the present invention, tag data may be developed using a social bookmarking system operated by multiple users. For instance, the well-known del.icio.us web service is a web service that provides users the ability to store and organize their bookmarks, share their bookmarks with others and find new bookmarks that may be of interest to them. According to one embodiment of the present invention, it is appreciated that a bookmarking system/service such as the del.icio.us service may be used to provide classification information for use in determining ad placement. Although various aspects of the present invention may be implemented with the del.icio.us web service, it should be appreciated that various aspects of the present invention may be implemented in other systems/services, and the invention is not limited thereto.

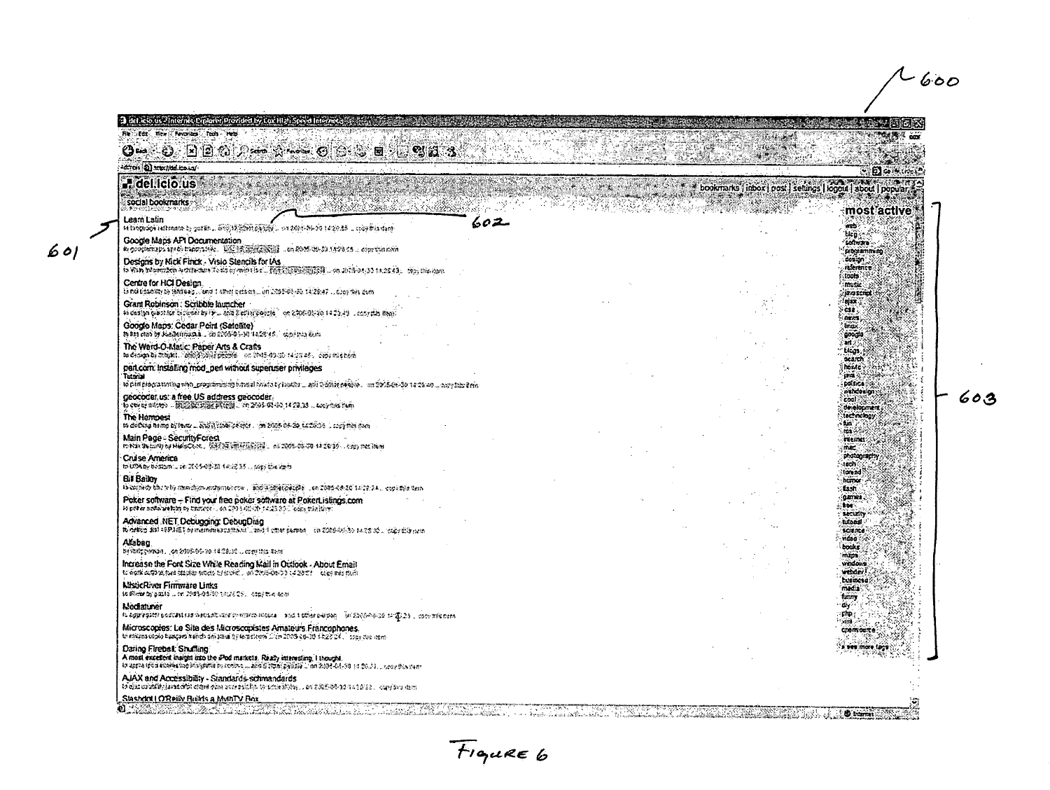

As discussed, the del.icio.us system is a social bookmark management system. An interface of one such social bookmark management system is shown by way of example in FIG. 6. FIG. 6 shows an interface 600 which may be, for example, a browser program interface (e.g., the Microsoft Windows Explorer browser). Within interface 600 may be displayed a main interface or page to a social bookmarking system (e.g., the del.icio.us system).

This interface may include one or more bookmarks (e.g., bookmark 601) that reference content, such as data stored on a website. Such data may be referenced by a link, such as a URL. Link data may be associated with each bookmark and stored in a database. For instance, link data may be collected from a user within an interface similar to interface 500 discussed above with reference to FIG. 5. Further, within an interface of the system, a bookmark may show an indication (e.g., indicator 602) of how many other users have bookmarked a particular portion of content.

The system allows users to easily add sites to a personal collection of links, to categorize those sites with keywords, and to share the collection not only between applications and systems, but also with other users. What makes the del.icio.us system a social bookmarking system is its ability to let users see links that other users have collected (e.g., a list of top-ranked bookmarks (e.g., list 603)), as well as showing other users who have bookmarked specific content (e.g., a website page referenced by a URL). Users can also view the bookmarks of links collected by others, and subscribe to bookmarks of people whose lists the user finds interesting.

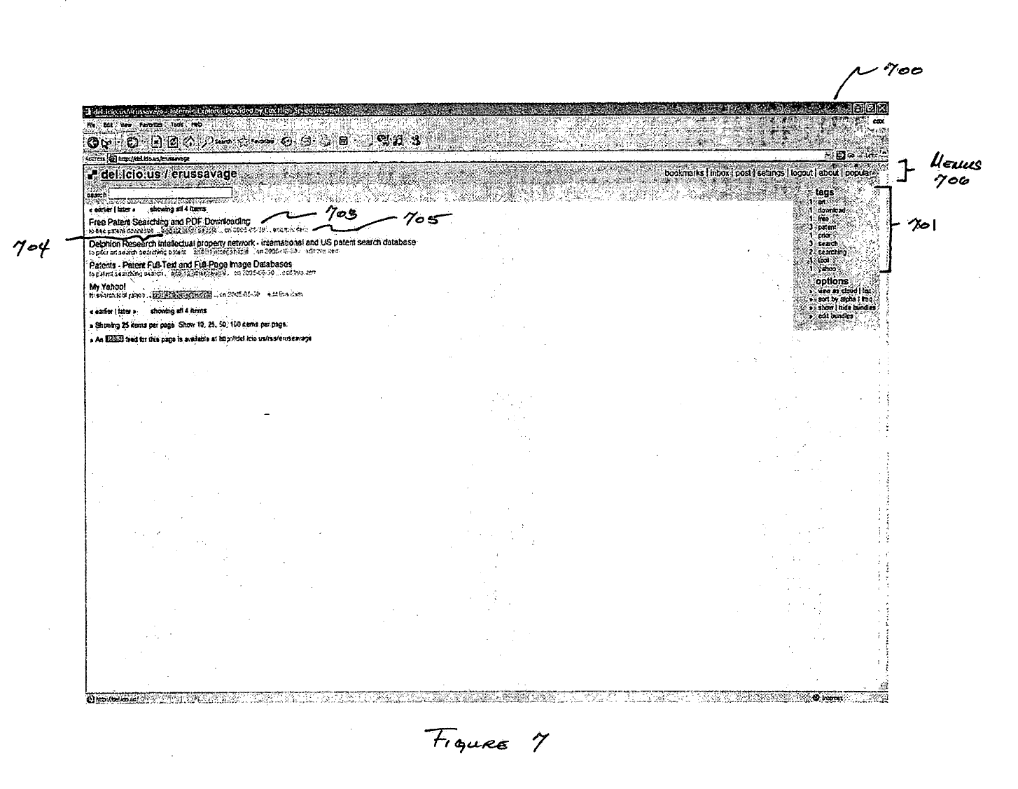

According to one embodiment, tags are one-word descriptors that a user can assign to any reference to content (e.g., a bookmark). A user is permitted to assign as many tags to a bookmark as desired, and rename, delete, add or merge tags together. A selectable list (e.g., list 701 of FIG. 7) of all of the user's current tags may be displayed, for example, on the right-hand side of the user's personal page, together with the number of bookmarks that have that tag. A user can assign tags to an item when the user first submits a bookmark, or by selecting an “edit” link (e.g., element 705 of FIG. 7) next to an existing bookmark. In one example, tags are automatically created the first time the user uses them. In a user's personal page such as the one shown in FIG. 7, a user can view an indicator (e.g., indicator 704) that shows how many other users have previously bookmarked a particular URL.

In another example interface, a user can merge, rename or delete tags whenever desired by selecting the “settings” tab on the user's personal page, and selecting “tags” from the “Settings” menu (e.g., of menus 706) on the right side of the interface (e.g., interface 700) or by entering the URL http://del.icio.us/USERNAME/settings/tags in an address field of the browser interface. The user may be then presented a pull-down menu of all the user's current tags, along with a text field. To rename all instances of a tag, the user enters a new tag name in the text area. To merge two tags, a user selects the tag to be merged and renames the tag to the name of an existing tag. To split a tag into two or more pieces, a user enters multiple tags in a “rename” field. To delete a tag, a user selects the tag from the pull down menu and selects a “Delete” button.

Features of the del.icio.us system can be broadly divided into the following four general functional areas:

Saving and Organizing Bookmarks

To save bookmarks in the del.icio.us system, a user creates an account and installs a del.icio.us “bookmarklet.” The bookmarklet is a program that adds a control (e.g., a button) to the browser's “links” or “bookmarks” toolbar. In one embodiment, the control acts similarly to the browser's built-in “bookmark this website” feature. In one specific example, the bookmark is stored on a server operated by the del.icio.us website. In another example, the feature may be part of an application (e.g., Explorer) or operating system, or may otherwise be previously installed on a client system.

After navigating to a website of interest and pressing the bookmarklet button, the user is presented with an interface with fields showing the URL of the currently viewed website, its title (editable) and additional fields for entering an optional paragraph-length description of the site and an optional list of free-form descriptive keywords. In the context of the del.icio.us system, keywords entered by a user to describe a particular bookmark are referred to hereinafter as “tags.”

Bookmarks saved by the user are listed on a personal page created for the user referred to hereinafter as a “personal” page (e.g., as shown by way of example in FIG. 7). A section of this personal page also lists all the tags used by a user and the number of bookmarks tagged with a given tag. Selecting (e.g., by “clicking on”) a tag name restricts the display of bookmarks to those tagged with that particular tag name. Additionally, a list of tags that have been used together with the selected tag is displayed as “related tags”. Tag/related tag lists serve, for example, as mnemonic and navigational aids with which the user can locate bookmarks previously saved by other users.

Sharing and Finding New Content

The del.icio.us system provides several mechanisms for finding bookmarks of interest saved by other users. These mechanisms provide the “social” aspect of the del.icio.us system.
The front page of the del.icio.us service (e.g., interface 600 of FIG. 6) may show an updated list of the top URLs bookmarked (and, therefore, classified) by del.icio.us users (e.g., list 603).
A page of recently popular URLs may be presented, upon which the URLs most frequently bookmarked by users are listed in order of popularity. Popularity may be determined, for example, by a ranking of the number of times a particular URL has been classified over a specified period of time.
Each listed URL may include a selectable numerical indicator (e.g., indicator 602) of how many other users have bookmarked the URL. Upon selection of the indicator, a list may be displayed of all bookmarks of that URL as described and tagged by others. This feature allows a user to find other users having similar interests.
Users are allowed to navigate to pages listing the bookmarks by all users for a particular tag. This feature allows, for example, the user to find URLs about a particular topic.
Users can subscribe to other user's bookmark lists, a particular tag used by a given user or bookmarks tagged with a given tag.
An aggregated list of the user's defined tags may be shown on a user's “inbox” page, allowing the user to create and track a personalized feed of content of interest.
   Syndication and Publishing

Various pages, such as, for example, user personal pages, main page, popular page, global and per-user tag pages, or other pages may be made available as RSS feeds, allowing users to subscribe to them with online or desktop aggregators and form their own custom views on the del.icio.us system classification data. A user can, for instance, use RSS feeds provided by the del.icio.us system to add the del.icio.us popular content to his or her my.yahoo.com page or view their personal inbox through, for example, the well-known Firefox browser's Live Bookmarks feature. Additionally, the del.icio.us system can periodically post the user's recent bookmarks to a user's blog, automating the maintenance of linkblogs.

Integration and Extension

The del.icio.us system provides a REST-style open programmatic application program interface (API) to a user's own content. A set of API calls are provided that mimic the functionality generally available to a user. That is, the API calls mimic the storing, editing, categorizing and retrieving functions performed with bookmarks and their associated information. This functionality allows third-party developers to develop tools that implement the del.icio.us system and integrate del.icio.us features into other products. Many tools have been developed, including, but not limited to del.icio.us extensions for several popular browsers, desktop clients, API bindings for popular programming languages and others.

According to one aspect of the present invention, such interfaces may be leveraged to permit other applications, operating systems, and/or computer systems to share classification data. In this way, classification data is more easily shared, and effort for classifying data in separate applications, computer systems, etc. are reduced. Further, the quality of classification data is increased as more entities (applications, computers, users) share and add to the classification data.

del.icio.us Technology

The del.icio.us system is, in one example, a database-driven system including a database interface program loaded on a client with the database being located on a server system. For instance, the del.icio.us system may include an architecture similar to system 200 as discussed above with reference to FIG. 2. In one embodiment, URL link and tag information posted by users may be stored, for example, in a relational database for later retrieval. The database information may, according to another embodiment, be broken up and distributed across several tables to enable fast processing of queries. Further, the system may maintain link and tag information posted by users in a structured format (e.g., XML). Full text indexing and distributed inverse indices may be used to locate information for retrieval.

Although various aspects of the present invention may be used with the del.icio.us system, it should be appreciated that other systems, services, and/or applications may be used. Further, systems having different components or architecture may be used to collect and store classification data. Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for selecting advertising comprising acts of:
collecting classification data from a plurality of users, wherein at least one portion of the classification data indicates a classification of content;
determining, based on the at least one portion of the classification data, an advertisement; and
associating the advertisement with the content.

2. The method according to claim 1, wherein the act of collecting classification data further comprises an act of collecting one or more tags.

3. The method according to claim 1, wherein the act of collecting the classification data further comprising an act of determining a classification performed through a user action.

4. The method according to claim 3, wherein the act of determining includes determining whether the user associated the content with a particular classification.

5. The method according to claim 2, wherein one or more tags include one or more keywords that describe the content.

6. The method according to claim 2, wherein the act of collecting the one ore more tags further comprises an act of collecting the one or more tags by a collaborative computer system operated by the plurality of users.

7. The method according to claim 1, wherein the content includes a website page and wherein the act of associating includes an act of associating the advertisement with the website page.

8. The method according to claim 1, wherein the advertisement includes data, and the act of associating further comprises an act of associating the data with the content.

9. The method according to claim 5, wherein one or more keywords are derived from at least one of the plurality of users.

10. The method according to claim 5, further comprising an act of inputting the one or more keywords into an ad-matching program.

11. The method according to claim 1, further comprising an act of providing the classification data to an entity to be used to determine the association of the advertisement with the content.

12. The method according to claim 1, wherein the act of collecting classification data is performed by a plurality of computer systems.

13. The method according to claim 1, wherein the classification data is shared among a plurality of computer systems.

14. The method according to claim 1, wherein the content is referenced by reference data, and wherein the act of associating includes an act of associating the advertisement with the reference data.

15. The method according to claim 14, wherein the reference data includes a Uniform Resource Locator (URL).

16. The method according to claim 1, wherein the classification data is shared among a plurality of application programs.

17. The method according to claim 1, wherein the classification data is shared among the plurality of users.

18. A system for selecting advertising, the system comprising:
an ad-matching component adapted to match an advertisement with content;
a classification system adapted to provide classification data collected from a plurality of users, wherein the classification data includes a portion that classifies the content and wherein the ad-matching component is adapted to use the portion to determine the association of the advertisement with the content.

19. The system according to claim 18, wherein the classification system is adapted to collect one or more tags.

20. The system according to claim 19, wherein one or more tags include one or more keywords that describe the content.

21. The system according to claim 19, wherein the classification system further comprises a collaborative computer system operated by the plurality of users.

22. The system according to claim 18, wherein the ad-matching component further comprises means for associating the advertisement with the content.

23. The system according to claim 20, wherein the one or more keywords are derived from at least one of the plurality of users.

24. The system according to claim 18, wherein the plurality of users collectively provide the classification data.

25. The system according to claim 18, wherein the content is referenced by reference data, and wherein the ad-matching component is adapted to associate the advertisement with the reference data.

26. The system according to claim 25, wherein the reference data includes a Uniform Resource Locator (URL).

27. The system according to claim 18, further comprising a plurality of application components that share the classification data.

28. The system according to claim 18, wherein the classification system is adapted to share the classification data among the plurality of users.

29. The system according to claim 18, wherein the classification system is adapted to determine a classification performed through a user action.

30. The system according to claim 29, wherein the classification system is adapted to determine whether the user associated the content with a particular classification.

31. A computer-readable medium having computer program code stored thereon, when executed by one or more computer systems, causes the computer system(s) to perform acts of:
collecting classification data from a plurality of users, wherein at least one portion of the classification data indicates a classification of content;
determining, based on the at least one portion of the classification data, an advertisement; and
associating the advertisement with the content.

32. The computer-readable medium according to claim 31, wherein the act of collecting classification data further comprises an act of collecting one or more tags.

33. The computer-readable medium according to claim 31, wherein the act of collecting the classification data further comprising an act of determining a classification performed through a user action.

34. The computer-readable medium according to claim 33, wherein the act of determining includes determining whether the user associated the content with a particular classification.

35. The computer-readable medium according to claim 32, wherein one or more tags include one or more keywords that describe the content.

36. The computer-readable medium according to claim 32, wherein the act of collecting the one ore more tags further comprises an act of collecting the one or more tags by a collaborative computer system operated by the plurality of users.

37. The computer-readable medium according to claim 31, wherein the content includes a website page and wherein the act of associating includes an act of associating the advertisement with the website page.

38. The computer-readable medium according to claim 31, wherein the advertisement includes data, and the act of associating further comprises an act of associating the data with the content.

39. The computer-readable medium according to claim 33, wherein one or more keywords are derived from at least one of the plurality of users.

40. The computer-readable medium according to claim 33, further comprising an act of inputting the one or more keywords into an ad-matching program.

41. The computer-readable medium according to claim 31, further comprising an act of providing the classification data to an entity to be used to determine the association of the advertisement with the content.

42. The computer-readable medium according to claim 31, wherein the act of collecting classification data is performed by a plurality of computer systems.

43. The computer-readable medium according to claim 31, wherein the classification data is shared among a plurality of computer systems.

44. The computer-readable medium according to claim 31, wherein the content is referenced by reference data, and wherein the act of associating includes an act of associating the advertisement with the reference data.

45. The computer-readable medium according to claim 44, wherein the reference data includes a Uniform Resource Locator (URL).

46. The computer-readable medium according to claim 31, wherein the classification data is shared among a plurality of application programs.

47. The computer-readable medium according to claim 31, wherein the classification data is shared among the plurality of users.
